(19) United States
(12) Patent Application Publication
(10) Pub. No.: US 2026/0065023 A1
(43) Pub. Date: Mar. 5, 2026

(54) Large Language Model (LLM) Selection Using Artificial Intelligence (AI) System Networks

(71) Applicant: Bank of America Corporation, Charlotte, NC (US)

(72) Inventor: Maharaj Mukherjee, Poughkeepsie, NY (US)

(21) Appl. No.: 18/823,954

(22) Filed: Sep. 4, 2024

(51) Int. Cl. G06N 3/0455

(52) U.S. Cl. CPC G06N 3/0455

(57) ABSTRACT

A computing platform may train, for a first LLM and using historical information for a plurality of LLMs and model network information, an LLM selection model to select one of the plurality of LLMs for providing a response to an input query. The computing platform may input, into the first LLM, an LLM prompt, which may cause the first LLM to generate an LLM output by: 1) comparing a first confidence level that the first output will be accurate to a confidence threshold, 2) based on identifying that the first confidence level meets or exceeds the confidence threshold, generating, using the first LLM, the LLM output, and 3) based on identifying that the first confidence level fails to meet the confidence threshold: identifying, using the LLM selection model, an alternative LLM of the plurality of LLMs, and input the LLM prompt into the alternative LLM to produce the LLM output.

### BACKGROUND

In some instances, enterprise organizations may utilize large language models (LLMs), deep learning models, and/or other generative artificial intelligence systems to provide information to customers and/or employees (e.g., through chatbots, or the like). In some instances, however, such systems may develop in a non-deterministic way based on their learning curves. As a result of the non-determinism, different models may produce different responses for the same queries, some of which may be more accurate or applicable than others.

### SUMMARY

Aspects of the disclosure provide effective, efficient, scalable, and convenient technical solutions that address and overcome the technical problems associated with generating accurate large language model (LLM) outputs. In accordance with one or more embodiments of the disclosure, a computing platform comprising at least one processor, a communication interface, and memory storing computer-readable instructions may train, for a first large language model (LLM) of a plurality of LLMs and using historical information for the plurality of LLMs and model network information, an LLM selection model, which may configure the LLM selection model to select one of the plurality of LLMs for providing a response to a given input query. The computing platform may input, into the first LLM, an LLM prompt, which may cause the first LLM to generate an LLM output by: 1) identifying a first confidence level that a first output by the first LLM will be accurate, 2) comparing the first confidence level that the first output will be accurate to a confidence threshold, 3) based on identifying that the first confidence level that the first output will be accurate meets or exceeds the confidence threshold, generating, using the first LLM, the LLM output, and 4) based on identifying that the first confidence level that the first output will be accurate fails to meet the confidence threshold: a) identifying, using the LLM selection model, an alternative LLM of the plurality of LLMs, where a second confidence level associated with the alternative LLM producing the first output may meet or exceed the confidence threshold, and b) inputting the LLM prompt into the alternative LLM, where the alternative LLM may produce the LLM output. The computing platform may transmit, to a user device associated with the LLM prompt, the LLM output and one or more commands directing the user device to display the LLM output, which may cause the user device to display the LLM output.

In one or more instances, the historical information may include one or more of: text information, images, speech information, structured information, three dimensional signals, literature information, cultural information, social information, geographical information, legal information, linguistic information, response accuracy information, or topics of expertise for a given model. In one or more instances, the model network information may indicate a network of LLMs, of the plurality of LLMs, to which the first LLM of the plurality of LLMs is connected to.

In one or more examples, each of the plurality of LLMs may be configured with a unique LLM selection model. In one or more examples, the first confidence level and the second confidence level may be generated based on consensus information associated with the plurality of LLMs.

In one or more instances, training the LLM selection model using the model network information may include establishing a knowledge graph indicating the plurality of LLMs and labelled based on expertise associated with each of the plurality of LLMs. In one or more instances, the computing platform may receive feedback information from the user device indicating an accuracy of the LLM output. The computing platform may update, based on the feedback information and using a dynamic feedback loop, the LLM selection model.

In one or more examples, generating the LLM output using the first LLM may include: 1) comparing the first confidence level to a third confidence threshold, 2) based on identifying that the first confidence level meets or exceeds the third confidence threshold, accepting the LLM output as accurate by the first LLM; and 3) based on identifying that the first confidence level is less than the third confidence threshold: a) requesting input from the plurality of LLMs on whether the LLM output is accurate, b) based on receiving a consensus response from the plurality of LLMs that the LLM output is accurate, accepting the LLM output as accurate by the first LLM, and c) based on receiving a consensus response from the plurality of LLMs that the LLM is inaccurate, accepting the LLM output as inaccurate by the first LLM. In one or more examples, based on accepting the LLM output as inaccurate by the first LLM, the computing platform may request generation of the LLM output by the alternative LLM.

In one or more instances, training the LLM selection model may further be based on: 1) a collection of questions and corresponding responses, along with which of the plurality of LLMs provided a most accurate response, or 2) a collection of topics, along with which of the plurality of LLMs has provided most accurate responses to questions associated with each topic in the collection of topics. In one or more instances, the plurality of LLMs may be configured to communicate in a peer to peer manner. In one or more instances, the model network information may further indicate a plurality of generative artificial intelligence (AI) models and deep learning models to which each of the plurality of LLMs are connected.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for performing selection of large language model (LLM) outputs using artificial intelligence (AI) system networks accordance with one or more example embodiments.

FIGS. 2A-2C depict an illustrative event sequence for performing selection of large language model (LLM) outputs using artificial intelligence (AI) system networks in accordance with one or more example embodiments.

FIG. 3 depicts an illustrative method for performing selection of large language model (LLM) outputs using artificial intelligence (AI) system networks in accordance with one or more example embodiments.

FIG. 4 depicts an illustrative user interface for performing selection of large language model (LLM) outputs using artificial intelligence (AI) system networks in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Large language models (LLMs) or generative artificial intelligence (AI) systems (or other deep learning models) may develop in a non-deterministic way based on their learning curve. Even where two LLMs or generative AI systems are architecturally equivalent and/or are trained on exactly the same materials, the LLMs/generative AI systems may differ because of the different orders in which their training data is ingested and/or how training is otherwise conducted. For example, training algorithms may use randomization in how data is split for training and/or testing, which may add to the non-uniformity of the final system even if common training data is used. Such non-deterministic differences may be more pronounced in LLMs and/or generative AI systems than in traditional deep learning models because of the increased volume of data used in building such LLMs and/or generative AI systems as compared to deep learning models. Furthermore, such LLMs or generative AI systems may use primarily unsupervised models, whereas traditional deep learning models may use supervised or semi-supervised models.

As a result of this non-determinism, responses for a given query (or equivalent queries) from these models may be different even when they are input into the same types of adaptation model or expert system. Accordingly, it may be important to evaluate these responses to identify which response may be most useful or effective for a user. Accordingly, described herein is a system and method for recommending a LLM or generative AI system (or any deep learning model in general) for answering a query, using a social network of generative artificial intelligence and LLM systems.

This social network may consist of participating generative AI/LLM/deep learning systems (collectively referred to herein as AI systems) in a peer to peer manner. Each participating AI system may maintain a collection of equivalent questions and responses, and which AI system has provided the best response and corresponding ratings. Additionally or alternatively, AI systems and their adaptations may be rated based on topics as well.

When a question is asked to any participating AI system, the question may be shared among all the participating AI systems and every system may independently create an answer to the system. The response may then be grouped and classified. If the responses can be independently verified, they may be marked as being correct/acceptable/useful or false/unacceptable/useless. If the responses can not be independently verified, the majority of responses may be considered to be correct/acceptable/useful. Over time the system that provided the most correct responses to a particular topic of questions may be rated highly by the systems. Additionally or alternatively, each system may use its own weightage as well on the ratings, which may, e.g., differ for each AI system.

When a question is posed to any of the participating AI systems, it may choose to make the response itself using its own adaptations, or seek expertise from another participating AI system which it might deem best to answer the question. For example, systems may maintain a list of topics, question/answer pairs, and/or ratings of participating AI systems that may be best to answer a particular question and/or address a particular topic. These ratings may be used to pose a question to the most knowledgeable system on that particular topic. Based on the response received from a participating system, a response may be modified and presented to the user. These and other features are described in greater detail below.

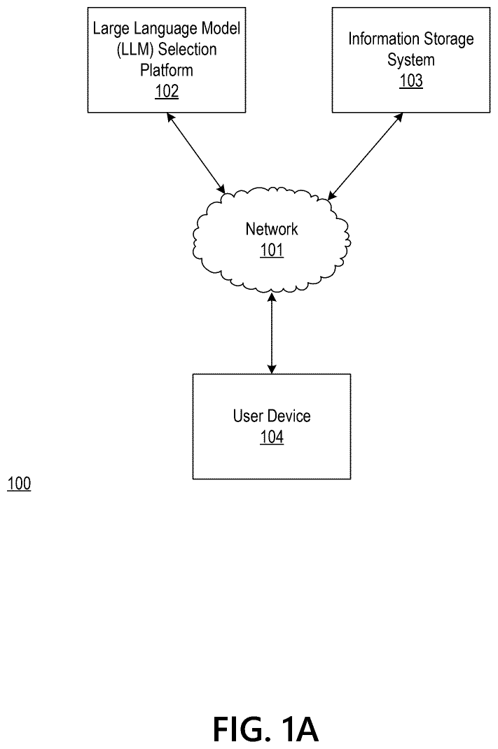

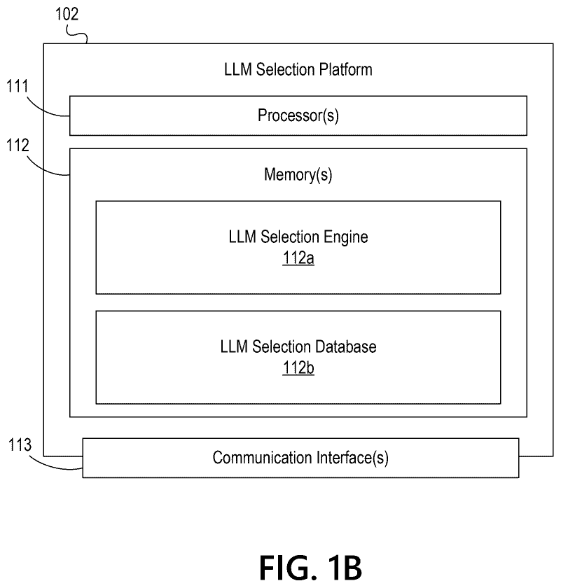

FIGS. 1A-1B depict an illustrative computing environment for selecting a large language model (LLM) using artificial intelligence (AI) system networks in accordance with one or more example embodiments. Referring to FIG. 1A, computing environment 100 may include one or more computer systems. For example, computing environment 100 may include LLM selection platform 102, information storage system 103, and/or user device 104.

LLM selection platform 102 may include one or more computing devices (servers, server blades, or the like) and/or other computer components (e.g., processors, memories, communication interfaces, or the like). For example, the LLM selection platform 102 may be configured to train, host, and apply a LLM selection model, configured to leverage a social network of LLM and/or AI based systems to select, for a given query, an optimal (e.g., in terms of accuracy, confidence, or the like) system to provide a response to the query. In some instances, the LLM selection platform 102 may maintain a stored list of topics, question/answer pairs, or the like associated with each system in the corresponding social network, which may, e.g., indicate expertise associated with each system. In some instances, LLM selection platform 102 may be configured to dynamically update the LLM selection model based on feedback on provided query responses, and/or other information. Any number of such LLM selection platforms may be used to implement the techniques described herein without departing from the scope of the disclosure. For example, each LLM, generative AI, and/or other AI based system within a given social network of AI systems may include a unique LLM selection model, which may, e.g., enable each system to select an optimal model/system accordingly.

Information storage system 103 may be or include one or more computing devices (e.g., servers, server blades, or the like) and/or other computer components (e.g., processors, memories, communication interfaces, or the like). For example, information storage system 103 may be configured to store information such as text information, images, speech information, structured information, three dimensional signals, literature information, cultural information, social information, geographical information, legal information, linguistic information, historical questions/response pairs, topic information, response feedback information, and/or other information. In these instances, the information storage system 103 may be configured to send such information to the LLM selection platform for the purpose of training the LLM selection platform 102. Any number of such information storage devices may be used to implement the techniques described herein without departing from the scope of the disclosure.

User device 104 may be or include one or more devices (e.g., laptop computers, desktop computer, smartphones, tablets, and/or other devices) configured for use in communicating with a LLM (hosted, e.g., by the LLM selection platform 102). For example, the user device 104 may be used to send LLM prompts/inputs to the LLM selection platform 102, and to receive responses that have been generated by the LLM selection platform 102. In some instances, the user device 104 may be configured to display one or more graphical user interfaces (e.g., LLM response interfaces, or the like), which may, e.g., be used to provide feedback on LLM outputs. Any number of such user devices may be used to implement the techniques described herein without departing from the scope of the disclosure.

Computing environment 100 also may include one or more networks, which may interconnect LLM selection platform 102, information storage system 103, and user device 104. For example, computing environment 100 may include a network 101 (which may interconnect, e.g., LLM selection platform 102, information storage system 103, and user device 104).

In one or more arrangements, LLM selection platform 102, information storage system 103, and user device 104 may be any type of computing device capable of receiving a user interface, receiving input via the user interface, and communicating the received input to one or more other computing devices, and/or training, hosting, executing, and/or otherwise maintaining one or more artificial intelligence models. For example, LLM selection platform 102, information storage system 103, user device 104, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of LLM selection platform 102, information storage system 103, and user device 104 may, in some instances, be special-purpose computing devices configured to perform specific functions.

Referring to FIG. 1B, LLM selection platform 102 may include one or more processors 111, memory 112, and communication interface 113. A data bus may interconnect processor 111, memory 112, and communication interface 113. Communication interface 113 may be a network interface configured to support communication between LLM selection platform 102 and one or more networks (e.g., network 101, or the like). Memory 112 may include one or more program modules having instructions that when executed by processor 111 cause LLM selection platform 102 to perform one or more functions described herein and/or one or more databases that may store and/or otherwise maintain information which may be used by such program modules and/or processor 111. In some instances, the one or more program modules and/or databases may be stored by and/or maintained in different memory units of LLM selection platform 102 and/or by different computing devices that may form and/or otherwise make up LLM selection platform 102. For example, memory 112 may have, host, store, and/or include LLM selection engine 112a and LLM selection database 112b. LLM selection engine 102a may have instructions that direct and/or cause LLM selection platform 102 to execute advanced techniques to leverage a social network of AI systems to produce LLM responses. For example, the LLM selection engine 112a may train, deploy, and/or otherwise refine models through both initial training and one or more dynamic feedback loops which may, e.g., enable continuous improvement of the models and further optimize the models for performing effective and accurate LLM output generation. LLM selection database 112b may store information that may be used by the LLM selection platform 102 and/or LLM selection engine 112a to effectively leverage a social network of AI systems to produce LLM responses.

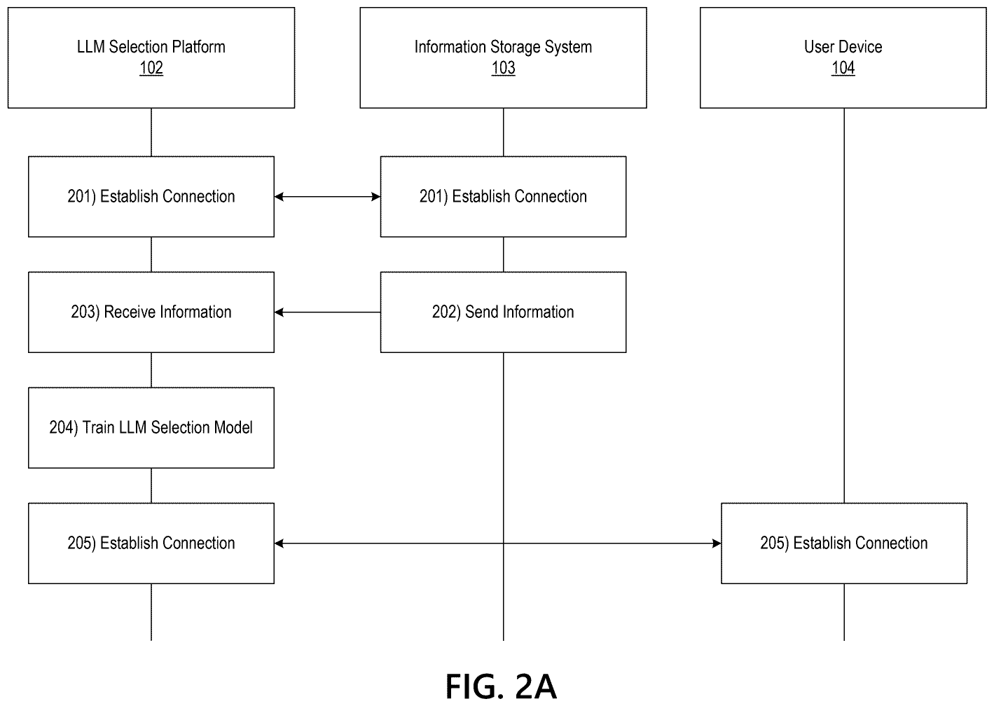

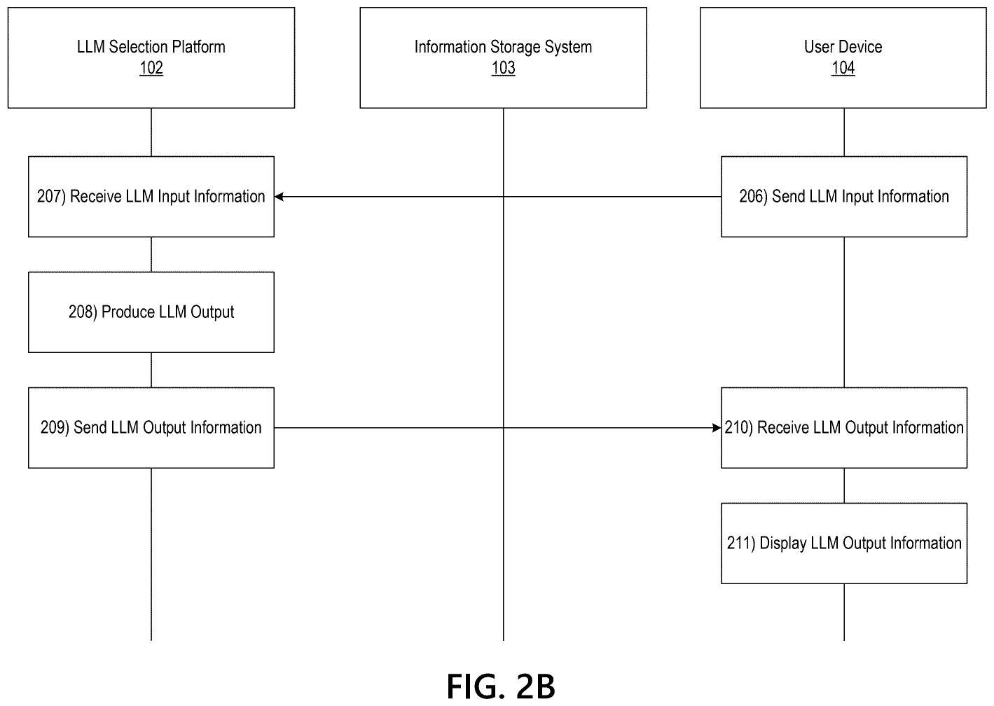

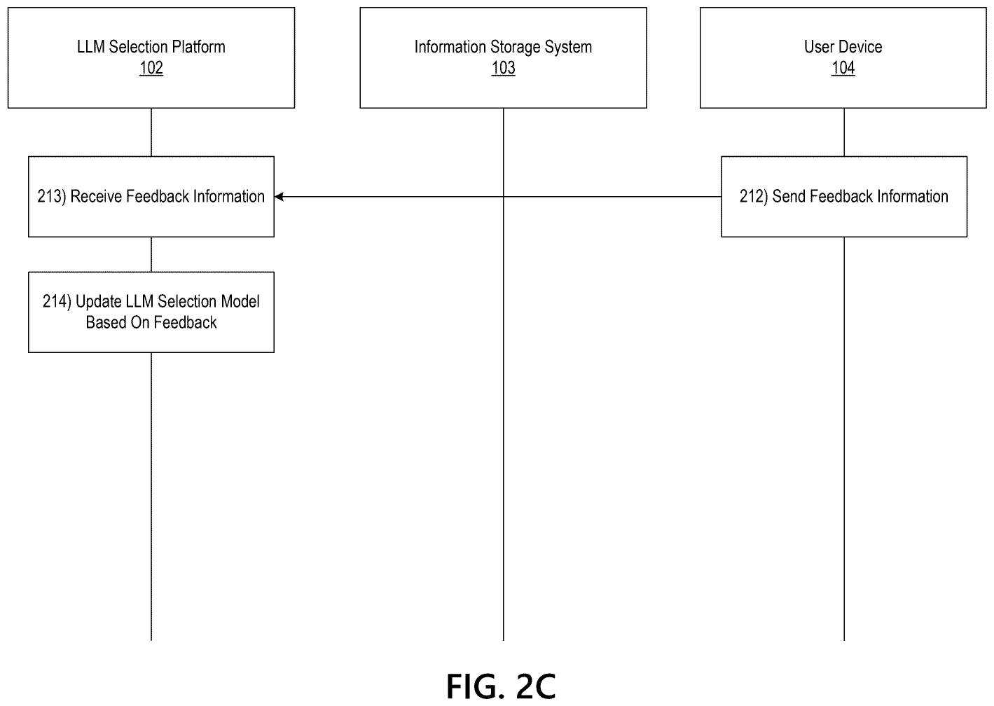

FIGS. 2A-2C depict an illustrative event sequence for selecting a large language model (LLM) using artificial intelligence (AI) system networks in accordance with one or more example embodiments. Referring to FIG. 2A, at step 201, the information storage system 103 may establish a connection with the LLM selection platform 102. For example, the information storage system 103 may establish a first wireless data connection with the LLM selection platform 102 to link the information storage system 103 with the LLM selection platform (e.g., in preparation for sending information that may be used to train an LLM selection model). In some instances, the information storage system 103 may identify whether or not a connection is already established with the LLM selection platform 102. If a connection is already established with the LLM selection platform 102, the information storage system 103 might not re-establish the connection. Otherwise, if a connection is not yet established with the LLM selection platform 102, the information storage system 103 may establish the first wireless data connection as described herein.

At step 202, the information storage system 103 may send historical information to the LLM selection platform 102. For example, the information storage system 103 may send text information, images, speech information, structured information, three dimensional signals, literature information, cultural information, social information, geographical information, legal information, linguistic information, historical questions/response pairs, topic information, response feedback information, and/or other information. For example, the information storage system 103 may send the historical information to the LLM selection platform 102 while the first wireless data connection is established.

At step 203, the LLM selection platform 102 may receive the historical information sent at step 202. For example, the LLM selection platform 102 may receive the historical information via the communication interface 113 and while the first wireless data connection is established.

At step 204, the LLM selection platform 102 may train an LLM selection model. For example, the LLM selection platform 102 may train the LLM selection model to produce responses to LLM and/or other AI based queries. To do so, the LLM selection model may be trained to establish a social network of associated artificial intelligence models (e.g., based on model network information indicating which other models/systems each given model or system is connected to). Additionally, the LLM selection model may be trained to establish confidence levels, indicating a confidence in accuracy of each of these LLM/AI systems in providing responses on particular topics, to particular questions, or the like. Based on stored correlations between these confidence levels and the corresponding LLM/AI systems, the LLM selection model may be trained to select a particular LLM/AI system to produce a response to a given input query.

In some instances, to perform such training, the LLM selection platform 102 may use the historical information received at step 203. For example, the LLM selection platform 102 may use historical questions/response pairs, topic information, response feedback information, and/or other feedback information associated with inputs and outputs of the various LLM/AI systems in the social network to generate stored correlations between these questions/topics and a confidence that responses generated by each LLM/AI system in the social network on these questions/topics will be accurate. For example, the LLM selection platform 102 may divide instances of feedback indicating accurate responses from a particular LLM/AI system by a total number of requests fed into the LLM/AI system, which may produce a success rate that may be used as the confidence score for that LLM/AI system on a particular topic. In some instances, the LLM selection platform 102 may generate multiple different confidence scores for each LLM/AI system, each associated with a given question, topic, or the like. For example, while a particular LLM/AI system may be an expert on a particular topic, it might not be trained to effectively provide responses on a different topic. Once these confidence scores are initially generated, they may be stored along with the corresponding questions/topics and the associated LLM/AI systems. For example, in some instances, the LLM selection platform 102 may generate a knowledge graph representing the social network of associated LLM/AI systems. In these instances, the nodes of the knowledge graph may represent the LLM/AI systems, whereas the edges between the nodes may indicate questions/topics and the corresponding confidence scores.

In some instances, the LLM selection model may be trained to establish one or more confidence thresholds, against which the confidence scores may be compared. For example, the LLM selection platform 102 itself may include an LLM or other AI model that may be configured to provide query responses. In these instances, the LLM selection platform 102 may be configured to compare a confidence score associated with its own model in providing a particular query response to a confidence threshold. In these instances, the LLM selection model may select the LLM selection platform's 102 own model if the confidence threshold is met or exceeded, or, where the confidence threshold is not met or exceeded, an alternative model may be selected by the LLM selection model (i.e., by selecting a highest ranked model, based on the confidence scores, with a confidence score that meets or exceeds the confidence threshold). In these instances, where an alternative model is selected, an output from that model may be used to modify a response of the LLM selection platform's 102 own model, or the response from the selected model may simply be used as the response.

In some instances, in training the LLM selection model, the LLM selection platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

At step 205, the user device 104 may establish a connection with the LLM selection platform 102. For example, the user device 104 may establish a second wireless data connection with the LLM selection platform 102 to link the user device 104 to the LLM selection platform 102 (e.g., in preparation for sending LLM prompts, or the like). In some instances, the user device 104 may identify whether or not a connection is already established with the LLM selection platform 102. If a connection is already established with the LLM selection platform 102, the user device 104 might not re-establish the connection. If a connection is not yet established with the LLM selection platform 102, the user device 104 may establish the second wireless data connection as described herein.

Referring to FIG. 2B, at step 206, the user device 104 may send LLM input information to the LLM selection platform 102. For example, the user device 104 may send a prompt configured for input into an LLM or other AI model hosted by the LLM selection platform 102. As a particular example, the user device 104 may enable a user to interact with a chatbot and/or other interface hosted by the LLM selection platform 102 and/or otherwise, and the LLM input information may include a prompt for response by the chatbot. For example, the user device 104 may send the LLM input information to the LLM selection platform 102 while the second wireless data connection is established. Although depicted as being sent to the LLM selection platform 102, in some instances, the LLM input information may be sent to a different computing system hosting the LLM (i.e., the LLM may be hosted by another system different than the LLM selection platform 102).

At step 207, the LLM selection platform 102 may receive the LLM input information sent at step 206. For example, the LLM selection platform 102 may receive the LLM input information via the communication interface 113 and while the second wireless data connection is established.

At step 208, the LLM selection platform 102 may produce an LLM output. For example, the LLM selection platform 102 may feed the LLM input information into the LLM selection model (which may, e.g., be an LLM corresponding to a chatbot, application program interface (API), website, search engine, or the like). In some instances, this LLM selection model may, e.g., be open-sourced, vendor sourced, or the like, and may be configured to perform: generating human-like text, searching and retrieving information, summarizing text, performing classification, understanding natural language and answering questions, analyzing sentiment, filtering content, translating language, assisting with computer code, generating content for creative applications, and/or other functions based on the LLM input information. In some instances, this LLM selection model may have been previously trained on a representation of training data to generate new content that may be similar to or inspired by existing data, and that may include human-like outputs such as natural language text, source code, images/videos, audio samples, and/or other outputs.

The LLM selection model may establish a correlation between the LLM input information and stored questions/topics for which the LLM selection model has a corresponding confidence score. Based on this correlation, the LLM selection model may generate a first confidence score indicating a confidence that a response, generated by a LLM or other AI model hosted by the LLM selection platform 102, may be accurate, responsive, satisfactory, or the like. For example, the LLM selection model may generate a value between 0 and 1 corresponding to the confidence score. The LLM selection model may compare this first confidence score to a confidence threshold (which may, e.g., be generated based on user input, consensus information among the LLM selection model and alternate LLMs/AI models, and/or otherwise). Based on identifying that the first confidence score meets or exceeds the confidence threshold, the LLM selection platform 102 may produce a response to the prompt identified in the LLM input information using this corresponding model (which may, e.g., be the LLM selection model itself).

In some instances, although the first confidence score meets or exceeds the confidence threshold, it might not exceed a second confidence threshold, which may, e.g., be higher than the original confidence threshold (e.g., indicating a higher degree of accuracy). In these instances, the LLM selection platform 102 may use its corresponding model to produce the LLM output, but may request consensus information from the alternate LLMs/AI model (e.g., to confirm whether or not the LLM output is correct). In doing so, the LLM selection platform 102 may effectively double check its response to the user's query.

Based on identifying that the first confidence score fails to meet or exceed the first confidence threshold, the LLM selection model may identify, based on stored correlations between the LLM information and previously submitted topics/questions, alternative LLMs and/or AI models associated with these topics/questions. The LLM selection model may identify confidence scores associated with these alternative LLMs in the context of providing a response to the LLM input information. The LLM selection model may compare these confidence scores to the confidence threshold, and may generate a ranking (from lowest to highest) of the alternate LLMs based on the confidence scores of any alternate LLMs with confidence scores that meet or exceed the confidence threshold. The LLM selection model may then select the highest ranked alternate LLM, and use this alternate LLM to generate the LLM output.

In some instances, the query of the LLM input information may be submitted to all of the alternate LLMs, and the confidence scores may be generated based on responses generated by these alternate LLMs. In other instances, the alternate LLMs themselves may be scored, and the query may be submitted only to the highest ranked LLM. In some instances, the LLM selection platform 102 may modify a response of its own associated LLM (e.g., which may be the LLM selection model) based on the response of the selected LLM. In other instances, the LLM selection platform 102 may simply select the response of the selected LLM as the response. In some instances, where no alternate models are identified as having a confidence score that meets or exceeds the confidence threshold, the LLM input information may be submitted to the alternate LLMs, and a consensus response may be produced by the LLM selection model based on these responses.

At step 209, the LLM selection platform 102 may send LLM output information to the user device 104 (e.g., indicating the LLM output produced at step 208). For example, the LLM selection platform 102 may send the LLM output information to the user device 104 via the communication interface 113 and while the second wireless data connection is established. In some instances, the LLM selection platform 102 may also send one or more commands directing the user device 104 to display the LLM output information.

At step 210, the user device 104 may receive the LLM output information sent at step 209. For example, the user device 104 may receive the LLM output information while the second wireless data connection is established. In some instances, the user device 104 may also receive the one or more commands directing the user device 104 to display the LLM output information.

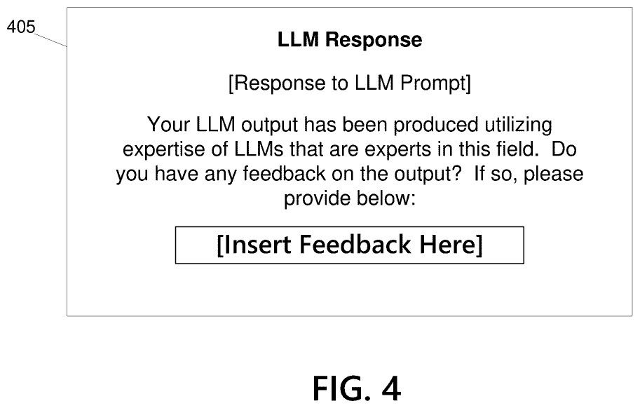

At step 211, based on or in response to the one or more commands directing the user device 104 to display the LLM output information, the user device 104 may display the LLM output information. For example, the user device 104 may display a graphical user interface similar to graphical user interface 405, which is illustrated in FIG. 4. For example, the user device 104 may display a response to the users LLM prompt, along with an indication that the output has been produced using a model with expertise in the particular regime of the user's query, and prompting for any feedback information.

Referring to FIG. 2C, at step 212, the user device 104 may send the feedback information (e.g., indicating whether or not the LLM output provided an accurate, relevant, adequate, and/or otherwise satisfactory response to the user's query) to the LLM selection platform 102. For example, the user device 104 may send the feedback information to the LLM selection platform 102 while the second wireless data connection is established.

At step 213, the LLM selection platform 102 may receive the feedback information from the user device 104. For example, the LLM selection platform 102 may receive the feedback information via the communication interface 113 and while the second wireless data connection is established.

At step 214, the LLM selection platform 102 may update the LLM selection model on the feedback information. In doing so, the LLM selection platform 102 may continue to refine the LLM selection model using a dynamic feedback loop, which may, e.g., increase the accuracy and effectiveness of the model in selecting an optimal LLM and/or other AI model. For example, the LLM selection platform 102 may reinforce, modify, and/or otherwise update the LLM selection model thus causing the model to continuously improve.

In some instances, the LLM selection platform 102 may continuously refine the LLM selection model. In some instances, the LLM selection platform 102 may maintain an accuracy threshold for the LLM selection model, and may pause refinement (through the dynamic feedback loops) of the model if the corresponding accuracy is identified as greater than the corresponding accuracy threshold. Similarly, if the accuracy fails to be equal or less than the given accuracy threshold, the LLM selection model may resume refinement of the model through the dynamic feedback loop.

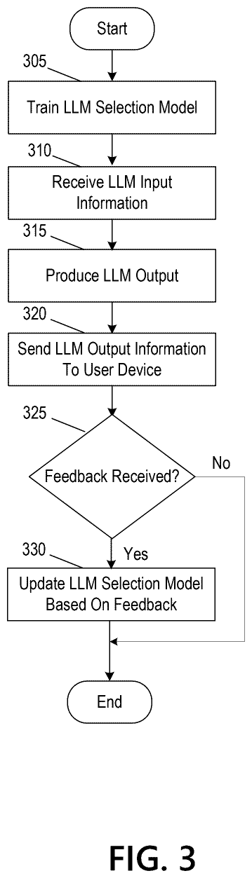

FIG. 3 depicts an illustrative method for selecting a large language model (LLM) using artificial intelligence (AI) system networks in accordance with one or more example embodiments. Referring to FIG. 3, at step 305, a computing platform comprising one or more processors, memory, and a communication interface may train an LLM selection model. At step 310, the computing platform may receive LLM input information. At step 315, the computing platform may produce an LLM output by feeding the LLM input information into the LLM selection model, which may, e.g., leverage a social network of additional models to produce the LLM output. At step 320, the computing platform may send the LLM output information to a user device. At step 325, the computing platform may determine whether feedback was received from the user device. If feedback was received, at step 330, the computing platform may update the LLM selection model based on the feedback. If no feedback was received, at step 325, the process may end.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, for a first large language model (LLM) of a plurality of LLMs and using historical information for the plurality of LLMs and model network information, an LLM selection model, wherein training the LLM selection model configures the LLM selection model to select one of the plurality of LLMs for providing a response to a given input query;
input, into the first LLM, an LLM prompt, wherein inputting the LLM prompt causes the first LLM to generate an LLM output by:
identifying a first confidence level that a first output by the first LLM will be accurate,
comparing the first confidence level that the first output will be accurate to a confidence threshold,
based on identifying that the first confidence level that the first output will be accurate meets or exceeds the confidence threshold, generating, using the first LLM, the LLM output,
based on identifying that the first confidence level that the first output will be accurate fails to meet the confidence threshold:
identifying, using the LLM selection model, an alternative LLM of the plurality of LLMs, wherein a second confidence level associated with the alternative LLM producing the first output meets or exceeds the confidence threshold, and
inputting the LLM prompt into the alternative LLM, wherein the alternative LLM produces the LLM output; and
transmit, to a user device associated with the LLM prompt, the LLM output and one or more commands directing the user device to display the LLM output, wherein sending the one or more commands directing the user device to display the LLM output causes the user device to display the LLM output.

2. The computing platform of claim 1, wherein the historical information includes one or more of: text information, images, speech information, structured information, three dimensional signals, literature information, cultural information, social information, geographical information, legal information, linguistic information, response accuracy information, or topics of expertise for a given model.

3. The computing platform of claim 1, wherein the model network information indicates a network of LLMs, of the plurality of LLMs, to which the first LLM of the plurality of LLMs is connected.

4. The computing platform of claim 1, wherein each of the plurality of LLMs is configured with a unique LLM selection model.

5. The computing platform of claim 1, wherein the first confidence level and the second confidence level are generated based on consensus information associated with the plurality of LLMs.

6. The computing platform of claim 1, wherein training the LLM selection model using the model network information comprises establishing a knowledge graph indicating the plurality of LLMs and labelled based on expertise associated with each of the plurality of LLMs.

7. The computing platform of claim 1, wherein the memory stores additional computer readable instructions that, when executed by the at least one processor, cause the computing platform to:
receive feedback information from the user device indicating an accuracy of the LLM output; and
update, based on the feedback information and using a dynamic feedback loop, the LLM selection model.

8. The computing platform of claim 1, wherein generating the LLM output using the first LLM further comprises:
comparing the first confidence level to a third confidence threshold;
based on identifying that the first confidence level meets or exceeds the third confidence threshold, accepting the LLM output as accurate by the first LLM; and
based on identifying that the first confidence level is less than the third confidence threshold:
requesting input from the plurality of LLMs on whether the LLM output is accurate,
based on receiving a consensus response from the plurality of LLMs that the LLM output is accurate, accepting the LLM output as accurate by the first LLM, and
based on receiving a consensus response from the plurality of LLMs that the LLM is inaccurate, accepting the LLM output as inaccurate by the first LLM.

9. The computing platform of claim 8, wherein the memory stores additional computer readable instructions that, when executed by the at least one processor, cause the computing platform to:
based on accepting the LLM output as inaccurate by the first LLM, request generation of the LLM output by the alternative LLM.

10. The computing platform of claim 1, wherein training the LLM selection model further comprises training the LLM selection model based on one or more of:
a collection of questions and corresponding responses, along with which of the plurality of LLMs provided a most accurate response, or
a collection of topics, along with which of the plurality of LLMs has provided most accurate responses to questions associated with each topic in the collection of topics.

11. The computing platform of claim 1, wherein the plurality of LLMs are configured to communicate in a peer to peer manner.

12. The computing platform of claim 1, wherein the model network information further indicates a plurality of generative artificial intelligence (AI) models and deep learning models to which each of the plurality of LLMs are connected.

13. A method comprising:
at a computing platform comprising at least one processor, a communication interface, and memory:
training, for a first large language model (LLM) of a plurality of LLMs and using historical information for the plurality of LLMs and model network information, an LLM selection model, wherein training the LLM selection model configures the LLM selection model to select one of the plurality of LLMs for providing a response to a given input query;
inputting, into the first LLM, an LLM prompt, wherein inputting the LLM prompt causes the first LLM to generate an LLM output by:
identifying a first confidence level that a first output by the first LLM will be accurate,
comparing the first confidence level that the first output will be accurate to a confidence threshold,
based on identifying that the first confidence level that the first output will be accurate meets or exceeds the confidence threshold, generating, using the first LLM, the LLM output,
based on identifying that the first confidence level that the first output will be accurate fails to meet the confidence threshold:
identifying, using the LLM selection model, an alternative LLM of the plurality of LLMs, wherein a second confidence level associated with the alternative LLM producing the first output meets or exceeds the confidence threshold, and
inputting the LLM prompt into the alternative LLM, wherein the alternative LLM produces the LLM output; and
transmitting, to a user device associated with the LLM prompt, the LLM output and one or more commands directing the user device to display the LLM output, wherein sending the one or more commands directing the user device to display the LLM output causes the user device to display the LLM output.

14. The method of claim 13, wherein the historical information includes one or more of: text information, images, speech information, structured information, three dimensional signals, literature information, cultural information, social information, geographical information, legal information, linguistic information, response accuracy information, or topics of expertise for a given model.

15. The method of claim 13, wherein the model network information indicates a network of LLMs, of the plurality of LLMs, to which the first LLM of the plurality of LLMs is connected.

16. The method of claim 13, wherein each of the plurality of LLMs is configured with a unique LLM selection model.

17. The method of claim 13, wherein the first confidence level and the second confidence level are generated based on consensus information associated with the plurality of LLMs.

18. The method of claim 13, wherein training the LLM selection model using the model network information comprises establishing a knowledge graph indicating the plurality of LLMs and labelled based on expertise associated with each of the plurality of LLMs.

19. The method of claim 13, further comprising:
receiving feedback information from the user device indicating an accuracy of the LLM output; and
updating, based on the feedback information and using a dynamic feedback loop, the LLM selection model.

20. One or more non-transitory computer-readable media storing instructions that, when executed by a computing platform comprising at least one processor, a communication interface, and memory, cause the computing platform to:
train, for a first large language model (LLM) of a plurality of LLMs and using historical information for the plurality of LLMs and model network information, an LLM selection model, wherein training the LLM selection model configures the LLM selection model to select one of the plurality of LLMs for providing a response to a given input query;
input, into the first LLM, an LLM prompt, wherein inputting the LLM prompt causes the first LLM to generate an LLM output by:
identifying a first confidence level that a first output by the first LLM will be accurate,
comparing the first confidence level that the first output will be accurate to a confidence threshold,
based on identifying that the first confidence level that the first output will be accurate meets or exceeds the confidence threshold, generating, using the first LLM, the LLM output,
based on identifying that the first confidence level that the first output will be accurate fails to meet the confidence threshold:
identifying, using the LLM selection model, an alternative LLM of the plurality of LLMs, wherein a second confidence level associated with the alternative LLM producing the first output meets or exceeds the confidence threshold, and
inputting the LLM prompt into the alternative LLM, wherein the alternative LLM produces the LLM output; and
transmit, to a user device associated with the LLM prompt, the LLM output and one or more commands directing the user device to display the LLM output, wherein sending the one or more commands directing the user device to display the LLM output causes the user device to display the LLM output.
